(19) United States
(12) Patent Application Publication
(10) Pub. No.: US 2015/0164091 A1
(43) Pub. Date: Jun. 18, 2015

(54) METHODS OF MAKING NATURAL SOURDOUGH STARTER FOR BAKING BREAD AND METHODS OF MAKING BREAD USING THE SAME

(71) Applicant: PARIS CROISSANT CO., LTD., Kyoungki-do (KR)

(72) Inventors: Chung-Kil Park, Seoul (KR); Cheon-Yong Lee, Seongnam-si (KR); Sang-Min Shim, Anyang-si (KR); Young-Ju Ban, Seoul (KR); Sin-Hak Oh, Anyang-si (KR); Byeong-Cheol Kim, Seoul (KR)

(21) Appl. No.: 14/232,481

(22) PCT Filed: Jan. 9, 2013
(86) PCT No.: PCT/KR2013/000152

§ 371 Date: Jan. 13, 2014

(30) Foreign Application Priority Data
Oct. 4, 2012 (KR) 10-2012-0109810
Oct. 4, 2012 (KR) 10-2012-0109811

(51) Int. Cl. A21D 8/04

(52) U.S. Cl. CPC A21D 8/04

(57) ABSTRACT

A method of preparing a natural sourdough starter capable of being continuously prepared while allowing bread to maintain uniform quality activities is provided. In particular, a method of preparing a natural sourdough starter for bread using a traditional Nuruk is provided. The method includes mixing purified water with a Songhak Nuruk, putting the resulting mixture into an incubator and separating and filtering a microorganism starter, mixing purified water, wheat flour and rye flour with the microorganism starter, putting the resulting mixture into a fermenter and fermenting the mixture at room temperature, mixing purified water, wheat flour and rye flour with the starter culture broth, putting the resulting mixture into an incubator and fermenting the mixture at a temperature of 11 to 13° C., and putting the sourdough starter into a refrigerator and refrigerating the sourdough starter at a temperature of 2 to 4° C.

### TECHNICAL FIELD

The present invention relates to a method of making a natural sourdough starter capable of making fermented bread having improved fragrance and flavor, a soft texture and an excellent volume, and, more particularly, to a method of making a natural sourdough starter for baking bread using microorganisms present in traditional Nuruks (Korean rice-wine starter) obtained in Korea to solve the problems regarding the artificial starter such as commercially available yeast or lactic acid bacteria, the natural sourdough starter being prepared through conventional mass production since the natural sourdough starter is able to be continuously prepared while allowing bread to maintain uniform quality activities, and a method of making bread using the same.

### BACKGROUND ART

In general, both of alcohol fermentation carried out by yeast and lactic acid fermentation carried out by lactic acid bacteria take part in fermenting bread. In this case, fermentation products produced by these fermentations serve to give flavors to bread and improve a taste. The yeast and lactic acid bacteria emit carbon dioxide while bread is fermented, thereby raising dough, acidify the dough at the presence of formed byproducts, and improve physical properties of the dough and biological values of proteins through an action of enzymes. Also, the yeast and lactic acid bacteria produce lactic acid or an organic acid of lactic acid, and thus contribute to increase the shelf life of products, inhibit the growth of pathogenic bacteria and prevent diseases.

In recent years, as the standards of living are improved and healthy lives are enjoyed, a well-being trend of seeking for better qualities of lives has spread. As a result, the consumers' buying tendency prefers health-oriented and environmentally friendly food products to products containing chemicals harmful to human bodies. Accordingly, the consumers have recognized bread fermented by natural yeast to have a unique and excellent taste and flavor as healthy bread, compared to bread fermented by commercially available yeast to have a constant taste and flavor. For this reason, research on this natural yeast has been increasingly conducted in connection with production of the natural yeast.

Also, as increasing attention has been paid to health with the higher food cultures, the functional foods which serve as a food rather than a medicine to perform body-modulating functions are required in the field of confectionery and bakery.

In consideration of such a trend, various kinds of research has been conducted to reduce the use of chemicals and improve qualities and functionalities of bread by adding a bread improver derived from a natural substance, or a functional material and a crude material, which is re-processed by bio-processing (an applied biological method) such as rice fermentation, to the bread.

As one of the most important factors that determine the qualities of bread products on production of bread, however, research and development of yeast remain to be improved in the field of yeast-making technology. Therefore, most of the bakers have used commercially available yeasts provided monopolistically from certain regions all over the world and by some bakers.

For example, fermented bread is generally made by artificially adding commercially available yeast during a kneading process and employing the resulting dough as a starter. However, the commercially available yeast is mass-proliferated by screening and culturing a certain starter strain. For this nature, since fermented bread made using the commercially available yeast alone has a short fermentation time and does not include other microorganisms, metabolites are not sufficiently produced by the microorganism. Therefore, the fermented bread has problems regarding degraded qualities, low storage stability and insufficient flavor and texture.

Meanwhile, a fermentation method using a sourdough includes mixing wheat flour, water and rye flour, activating microorganisms present inside the mixture to prepare a sourdough starter, employing some of the sourdough starter for a kneading process, and storing the other sourdough starter for use in the next kneading process.

When dough and bread is made using this sourdough starter, various microorganisms such as yeast, bacteria and molds derived from a crude material may be mixed in the starter, which makes it possible to expect rich flavors. However, the dough and bread may be contaminated with pathogenic microorganisms or various germs, an additional fermentation time is required when the microorganisms are present at a low concentration, and the low uniformity and reproducibility makes it difficult to maintain the same constant conditions. Therefore, since it is impossible to make bread having uniform quality activities, the eating qualities of bread may be negatively affected.

Also, since the sourdough starter is peculiarly prepared according to the climate of producer countries and the properties of bakery, the characteristics of the sourdough starter may vary according to the climates and topographies of each country. Also, the characteristics of the sourdough starter depend on a temperature of water used, a method of managing a starter, a fermentation period, etc. Therefore, although the same blend is used to make a starter, it is difficult to prepare the same starter.

### Patent Documents

Korean Registered Patent No. 10-0963148 (2010 Jun. 21)
Korean Registered Patent No. 10-1095805 (2011 Dec. 21)
Korean Registered Patent No. 10-1074340 (2011 Oct. 18)
Korean Registered Patent No. 10-0430040 (2004 May 4)
Korean Patent Publication No. 10-2011-0113916 (2011 Oct. 19)

### Non-Patent Documents

Effects of Liquid Broth Cultured with Red Koji on the Rheological Properties of White Pan Bread Dough: Korean J. Food Sci. Technol. Vol. 43, No. 2. pp. 235 to 239 (2011)
Development of the Formula for Natural Bread-Making Starter: J. Korean Soc. Food Sci. Nutr. 32(8), 1245 to 1252(2003)
Effects of Sourdough on the Quality Characteristics of Rye-Wheat Mixed Bread: J. Korean Soc. Food Sci. Nutr. 37(5), 625 to 632(2008)
Rheological Properties of Bread Dough Added with Flour Ferments by Seed Mash and Lactic Acid Bacteria: J. Korean Soc. Food Sci. Nutr. 38(3), 346 to 351(2009)

### DISCLOSURE OF INVENTION

### Technical Problem

Accordingly, the inventors have tried to solve the above-described general issues and problems, and thus conducted ardent research to develop a natural sourdough starter capable of enabling uniform and continuous production as well as improving the bread qualities such as texture and flavor while maintaining excellent fermentability and taste. As a result, the inventors have develop a novel natural sourdough starter capable of making natural fermented bread having good eating quality and uniform quality activities by selecting a Songhak Nuruk including high-quality microorganisms associated with fermentations under the optimum culture medium conditions from traditional Nuruks naturally occurring in Republic of Korea and applying the Songhak Nuruk to a starter, and applied the natural sourdough starter to a baking process to prove an effect of the natural sourdough starter on improvement of the bread qualities. Therefore, the present invention is completed based on the above-described facts.

Therefore, the present invention is designed to solve the problems of the prior art, and therefore it is an object of the present invention to provide a method of making a natural sourdough starter for bread using a traditional Nuruk.

It is another object of the present invention to provide a method of making a natural sourdough starter for bread capable of maintaining uniform quality activities.

It is still another object of the present invention to provide a method of making bread using a natural sourdough starter derived from traditional Nuruk.

### Solution to Problem

In order to accomplish the above objects, one exemplary embodiment of the present invention provides a method of preparing a natural sourdough starter for bread. Here, the method includes mixing 450 to 500 parts by weight of purified water with 50 to 55 parts by weight of a Songhak Nuruk, putting the resulting mixture in an incubator at a temperature of 20 to 23° C. and a relative humidity of 80 to 85% and separating and filtering a microorganism starter for 4 to 5 hours (starter separation process), mixing 640 to 660 parts by weight of purified water, 940 to 960 parts by weight of wheat flour and 95 to 105 parts by weight of rye flour with 390 to 410 parts by weight of the microorganism starter separated(=Nuruk extract) in the starter separation process, putting the resulting mixture in a fermenter at a temperature of 24 to 26° C. and a relative humidity of 80 to 85% and fermenting the mixture for 46 to 50 hours (starter culturing process), mixing 1,000 to 1,100 parts by weight of purified water, 900 to 1,000 parts by weight of wheat flour and 95 to 105 parts by weight of rye flour with 690 to 710 parts by weight of the starter culture broth cultured in the starter culturing process, putting the resulting mixture in an incubator at a temperature of 11 to 13° C. and fermenting the mixture for 14 to 16 hours (sourdough starter preparation process), and putting the sourdough starter prepared in the sourdough starter preparation process in a refrigerator and storing the sourdough starter at a temperature of 2 to 4° C. for 10 to 12 hours.

Accordingly, the method according to the present invention is applicable to continuous production of a bread product while allowing the bread product to maintain uniform quality activities, thereby overcoming the limits of the artificial starter such as commercially available yeast or lactic acid bacteria. Also, the method of the present invention may be useful in enhancing the fragrance and flavor of bread, as well as improving the fermentability and texture of the bread when a sourdough starter is added during a bread-making process.

According to another exemplary embodiment of the present invention, the method may further include mixing 1,000 to 1,100 parts by weight of purified water, 900 to 1,000 parts by weight of wheat flour and 95 to 105 parts by weight of rye flour with 690 to 710 parts by weight of the sourdough starter undergoing the sourdough starter refrigeration process, putting the resulting mixture in an incubator at a temperature of 11 to 13° C. and fermenting the mixture for 14 to 16 hours (sourdough starter sub-culturing process).

According to still another exemplary embodiment of the present invention, the microorganism starter separated from the Nuruk in the starter separation process may be filtered using a sieve having a mesh size of 50 to 100 mesh to remove wheat bran ingredients, and used for various applications.

Also, another exemplary embodiment of the present invention provides a method of making bread. Here, the method includes (A) mixing 450 to 500 parts by weight of purified water with 50 to 55 parts by weight of Nuruk, putting the resulting mixture in an incubator at a temperature of 20 to 23° C. and a relative humidity of 80 to 85% and separating a microorganism starter for 4 to 5 hours, (B) mixing 640 to 660 parts by weight of purified water, 940 to 960 parts by weight of wheat flour and 95 to 105 parts by weight of rye flour with 390 to 410 parts by weight of the microorganism starter separated in Operation (A), putting the resulting mixture in a fermenter at a temperature of 24 to 26° C. and a relative humidity of 80 to 85% and fermenting and culturing the mixture for 46 to 50 hours, (C) mixing 1,000 to 1,100 parts by weight of purified water, 900 to 1,000 parts by weight of wheat flour and 95 to 105 parts by weight of rye flour with 690 to 710 parts by weight of the starter culture broth cultured in Operation (B), putting the resulting mixture in an incubator at a temperature of 11 to 13° C. and fermenting the mixture for 14 to 16 hours to prepare a sourdough starter, (D) putting the sourdough starter prepared in Operation (C) in a refrigerator and refrigerating the sourdough starter at a temperature of 2 to 4° C. for a predetermined period of time, (E) kneading 55 to 65 parts by weight of the sourdough starter undergoing Operation (D) with 70 parts by weight of wheat flour, 30 parts by weight of rye flour, 5.3 parts by weight of a sugar, 1.8 parts by weight of a sun-dried salt and 44 to 50 parts by weight of purified water for 4 to 5 minutes using a mixer, putting the resulting mixture into a fermenter and primarily fermenting the mixture at a temperature of 27±1° C. and a relative humidity of 75% for 200 minutes, (F) dividing the dough undergoing Operation (E) into dough pieces having a weight of 300 to 350 g, intermediately fermenting the dough at a temperature of 27±1° C. and a relative humidity of 75% for 30 minutes, removing a gas from the dough, shaping and panning the dough, putting the dough in a fermenter and secondarily fermenting the dough at a temperature of 38±1° and a relative humidity of 80 to 85% for 120 minutes, and (G) toasting the secondarily fermented dough undergoing Operation (F) for 45 minutes in a tech oven whose upper portion is set to 190° C. and lower portion is set to 220° C. and cooling an internal temperature of the tech oven to 32° C. at room temperature.

Accordingly, the method according to the present invention is applicable to continuous production of a bread product while allowing the bread product to maintain uniform quality activities, thereby overcoming the limits of the artificial starter such as commercially available yeast or lactic acid bacteria. Also, the method of the present invention may be useful in enhancing the fragrance and flavor of bread, as well as improving the fermentability and texture of the bread.

### Advantageous Effects of Invention

The natural sourdough starter according to the present invention having the configuration as described above can be continuously prepared using a naturally occurring Nuruk while allowing bread to maintain uniform quality activities and good uniformity and reproducibility, thereby overcoming the limits of the artificial starter such as commercially available yeast or lactic acid bacteria. Also, the natural sourdough starter of the present invention can be used to obtain high-quality bread having an excellent taste by enhancing the fragrance and flavor of bread, as well as improving the fermentability and texture of the bread when the sourdough starter is added during a bread-making process.

### BRIEF DESCRIPTION OF DRAWINGS

These and other features, aspects, and advantages of preferred embodiments of the present invention will be more fully described in the following detailed description, taken accompanying drawings. In the drawings:

FIG. 1 is a graph illustrating the gassing power measured for sourdough starters prepared in Example 1 and Comparative Examples 1 to 3 according to one exemplary embodiment of the present invention;

FIG. 2 is a graph illustrating gassing power measured for sourdough starters prepared in Examples 1 and 2 according to one exemplary embodiment of the present invention; and

FIG. 3 is a graph illustrating the gassing power measured for sourdough starters prepared in Example 1 and Comparative Examples 4 and 5 according to one exemplary embodiment of the present invention.

### BEST MODE FOR CARRYING OUT THE INVENTION

Hereinafter, preferred embodiments of the present invention will be described in detail referring to the accompanying drawings.

Prior to the description, it should be understood that the terminology used in the specification and appended claims should not be construed as limited to general and dictionary meanings, but interpreted based on the meanings and concepts corresponding to technical aspects of the present invention on the basis of the principle that the inventor is allowed to define terms appropriately for the best explanation.

Therefore, the description proposed herein is just a preferable example for the purpose of illustrations only, not intended to limit the scope of the invention, so it should be understood that other equivalents and modifications could be made thereto without departing from the scope of the invention.

(1) Starter Separation Process

450 to 500 parts by weight, preferably 450 parts by weight, of purified water was homogenously mixed with 50 to 55 parts by weight, preferably 50 parts by weight, of Nuruk, and the resulting mixture was put into an incubator at a temperature of 20 to 23° C. and a relative humidity of 80 to 85%. Then, a microorganism starter was separated for 4 to 5 hours.

Here, the Nuruk was a Songhak Nuruk kindly provided by a Songhak Gokja (so-called a Songhak Nuruk producer) prepared at Songjeong-ri. Gwangsan-gu Gwangju-si, Republic of Korea, and the microorganism starter separated from the Nuruk in the starter separation process was filtered using a sieve having a mesh size of 50 to 100 mesh to remove wheat bran ingredients.

The characteristics of the Songhak Nuruk were analyzed, and the analysis results were listed in the following Table 1.

TABLE 1

| | | Total | Water | Viable cell(cfu/g) | |
|---|---|---|---|---|---|
| Items | pH | acidity | content | Lactic acid bacteria | fungus |
| Experimental | 6.19 | 0.56 | 7.52% | 2.6 × 10⁶ | 3.4 × 10⁸ |
| value | | | | | |

In this case, the pH value in each process was measured according to an AACC method, as follows. That is, 20 g of a sample and 100 ml of distilled water was put into a 250 ml beaker, and homogenously mixed. Then, the resulting mixture was filtered at 25° C., and the filtrate was measured using a pH meter.

2 or 3 drops of a mixed indicator of Bromothymol Blue (B.T.B) and Neutral Red (N.R) were added to 10 ml of the filtrate obtained for pH measurement, and titrated until a N/10 sodium hydroxide solution (0.1N NaOH) turned light green. Then, the total acidity was calculated by applying the titer (ml) to the following equation.

Acidity (meq/kg)=a×f×100/amount of collected sample (g)

a: Amount (ml) of 0.1N sodium hydroxide solution used for titration

f: Titer of 0.1N sodium hydroxide solution

The water content was measured at 105° C. using an air-oven method.

1 ml of a sample properly diluted with a saline solution was put into a petri-dish, an MRS agar medium supplemented with 0.01% cycloheximide was mixed at a certain amount and coagulated, and the resulting mixture was then put into an incubator and anaerobically cultured at 35° C. for 48 to 72 hours. Then, the lactic acid bacteria counts were measured using a colony counter. Except for plates on which an excessively high population of colonies grows, plates on which 30 to 300 colonies grow per plate were selected to count the colonies, and the lactic acid bacteria counts in the sample was calculated by multiplying the number of the colonies by a dilution factor.

1 ml of a sample properly diluted with a saline solution was put into a petri-dish, a PDA agar medium supplemented with 0.01% chloramphenicol was mixed at a certain amount and coagulated, and the resulting mixture was then put into an incubator and aerobically cultured at 28° C. for 48 to 72 hours. Then, the fungus counts were measured using a colony counter. Except for the plates on which an excessively high population of colonies grows, plates on which 30 to 300 colonies grow per plate were selected to count the colonies, and the fungus counts in the sample was calculated by multiplying the number of the colonies by a dilution factor.

(2) Starter Culturing Process

640 to 660 parts by weight of purified water, 940 to 960 pans by weight of wheat flour and 95 to 105 parts by weight of rye flour, preferably 650 parts by weight of purified water, 950 parts by weight of wheat flour and 100 parts by weight of rye flour, were homogenously mixed with 390 to 410 parts by weight, preferably 400 parts by weight, of the microorganism starter separated(=Nuruk extract) in the starter separation process. Then, the resulting mixture was put into a fermenter at a temperature of 24 to 26° C. and a relative humidity of 80 to 85%, preferably at a temperature of 25° C. and a relative humidity of 85%, and fermented for 46 to 50 hours, preferably 48 hours, to obtain a starter culture broth.

Here, in consideration of a gluten content, medium/hard flour (Mildawon Co., Ltd.) was used as the wheat flour and Type 1800 was used as the rye flour (made in the Republic of Finland).

(3) Sourdough Starter Preparation Process

1,000 to 1,100 parts by weight of purified water, 900 to 1,000 parts by weight of wheat flour and 95 to 105 parts by weight of rye flour, preferably 1050 parts by weight of purified water. 950 parts by weight of wheat flour and 100 parts by weight of rye flour, were homogenously mixed with 690 to 710 parts by weight, preferably 700 parts by weight, of the starter culture broth cultured in the starter culturing process. Then, the resulting mixture was put into an incubator at a temperature of 1 to 13° C., and fermented for 14 to 16 hours to obtain a sourdough starter.

(4) Sourdough Starter Refrigeration Process

The sourdough starter prepared in the sourdough starter preparation process was put into a refrigerator and refrigerated at a temperature of 2 to 4° C. for a predetermined time.

(5) Sourdough Starter Sub-Culturing Process

1,000 to 1,100 parts by weight of purified water, 900 to 1,000 parts by weight of wheat flour and 95 to 105 parts by weight of rye flour, preferably 1,050 parts by weight of purified water, 950 parts by weight of wheat flour and 100 parts by weight of rye flour, were mixed with 690 to 710 parts by weight, preferably 700 parts by weight, of the sourdough starter refrigerated in the sourdough starter refrigeration process. Then, the resulting mixture was put into an incubator, and fermented at a temperature of 11 to 13° C. for 14 to 16 hours to obtain a sub-cultured sourdough starter.

The natural sourdough starter prepared according to one exemplary embodiment of the present invention as described above may be applied to mass production of bread which was continuously prepared while allowing bread to maintain uniform quality activities and good uniformity and reproducibility, thereby maximizing the use and efficiency of the natural sourdough starter. That is, the natural sourdough starter according to one exemplary embodiment of the present invention was applicable to bread made for franchise sales to differentiate a bread product. As a result, the quality competitiveness may be secured, and the market competitiveness may be also strengthened.

### Example 1

450 g of purified water was homogenously mixed with 50 g of Songhak Nuruk at room temperature, and a microorganism starter was separated for 4 hours and 30 minutes in an incubator which was set to a temperature to 22° C. and a relative humidity of 80%. Thereafter, the microorganism starter was filtered using a sieve having a mesh size of 50 mesh to remove wheat bran ingredients. In this condition, 650 g of purified water, 950 g of wheat flour and 100 g of rye flour were homogenously mixed with 400 g of the microorganism starter, and the resulting mixture was put into a fermenter at a temperature of 25° C. and a relative humidity of 85% and fermented for 48 hours. Then, 1,050 g of purified water, 950 g of wheat flour and 100 g of rye flour homogenously mixed with 700 g of the starter culture broth at room temperature, and the resulting mixture was then put into an incubator at a temperature of 12° C. and fermented for 15 hours to prepare a natural sourdough starter. In this case, a finished dough temperature of a dough (i.e., a temperature when fermentation of a dough was finished) was maintained at 25 to 27° C.

Also, the sourdough starter was put into a refrigerator whose temperature was set to 2 to 4° C., and refrigerated for at least 10 hours.

Next, 1,050 g of purified water 950 g of wheat flour and 100 g of rye flour were homogenously mixed with 700 g of the sourdough starter undergoing the sourdough starter refrigeration process. Then, the resulting mixture was put into an incubator at a temperature of 11 to 13° C., and fermented for 14 to 16 hours to obtain a sub-cultured sourdough starter. In this case, a finished dough temperature of a dough was maintained at 25 to 27° C.

Then, 1,050 g of purified water, 950 g of wheat flour and 100 g of rye flour were homogenously mixed with 700 g of the sourdough starter undergoing the sourdough starter refrigeration process, and the resulting mixture was then put into an incubator at a temperature of 12° C. and fermented for 14 to 16 hours. Then, these operations were repeatedly performed to sub-culture a natural sourdough starter.

### Example 2

A natural sourdough starter was prepared in the same manner as in Example 1, except that 576 g of purified water was used at room temperature during the sub-culturing of the sourdough starter undergoing the sourdough starter refrigeration process.

### Example 3

A natural sourdough starter was prepared in the same manner as in Example 1, except that a fermentation temperature of the incubator was changed to 5° C. during the sub-culturing of the sourdough starter undergoing the sourdough starter refrigeration process.

### Example 4

A natural sourdough starter was prepared in the same manner as in Example 1, except that a fermentation temperature of the incubator was changed to 17° C. during the sub-culturing of the sourdough starter undergoing the sourdough starter refrigeration process.

### Comparative Example 1

A natural sourdough starter was prepared in the same manner as in Example 1, except that Jinju Nuruk of the research institute of Jinju-Gokja was used instead of the Songhak Nuruk used to separate a microorganism starter.

### Comparative Example 2

A natural sourdough starter was prepared in the same manner as in Example 1, except that Sansung Nuruk from Geumjeong Sansung, Geumjeong-gu, Busan, Republic of Korea was used instead of the Songhak Nuruk used to separate a microorganism starter.

### Comparative Example 3

A natural sourdough starter was prepared in the same manner as in Example 1, except that Sangju Nuruk from the Sangju-Gokja in Gyeongsangbuk-do. Republic of Korea was used instead of the Songhak Nuruk used to separate a microorganism starter.

### Comparative Example 4

A natural sourdough starter was prepared in the same manner as in Example 1, except that 1,050 g of wheat flour produced in Republic of Korea was used instead of the wheat flour and rye flour during preparation of the starter culture broth.

### Comparative Example 5

A natural sourdough starter was prepared in the same manner as in Example 1, except that the microorganism starter was not added during preparation of the starter culture broth.

### Experiment Example 1

The natural sourdough starter prepared in Example 1 was sub-cultured to measure a pH value, total titratable acidity (TTA) and gassing power (fermentation ratio).

In this case, 20 g of a sample and 100 ml of distilled water were put into a 250 ml beaker, and homogenously mixed. Then, the pH value of the resulting mixture was measured using a pH meter. Also, the TTA was referred as an amount of a NaOH solution used when a sample was titrated with a 0.1N NaOH solution in pH measurement and the pH value of the sample reached pH 6.6 and 8.5, and the gassing power was a value obtained by putting 50 g of each sample into a machine for measuring gassing power (fermometer) and measuring the sample at a temperature of 27° C. for 10 hours. The results are listed in the following Table 2.

TABLE 2

| Sub-culturing | Fermentation | | TTA | | Gassing power |
|---|---|---|---|---|---|
| frequency | time (hr) | pH | pH 6.6 | pH 8.5 | (ml) |
| 1^{st} | 0 | 5.25 | 3.31 | 7.07 | 361.80 |
| | 15 | 4.24 | 9.72 | 15.09 | |
| 5^{th} | 0 | 5.05 | 3.92 | 7.35 | 320.38 |
| | 16 | 3.99 | 12.15 | 16.63 | |
| 10^{th} | 0 | 5.18 | 3.82 | 8.42 | 333.09 |
| | 16 | 4.37 | 11.00 | 15.66 | |
| 15^{th} | 0 | 5.26 | 3.76 | 6.28 | 311.97 |
| | 16 | 4.43 | 10.80 | 15.12 | |
| 20^{th} | 0 | 5.12 | 3.60 | 6.18 | 318.40 |
| | 16 | 4.19 | 10.86 | 15.20 | |
| 25^{th} | 0 | 5.28 | 3.68 | 6.40 | 311.30 |
| | 16 | 4.40 | 10.20 | 14.84 | |
| 30^{th} | 0 | 5.06 | 3.61 | 6.57 | 314.30 |
| | 16 | 4.24 | 10.30 | 15.10 | |
| 35^{th} | 0 | 5.12 | 3.80 | 7.00 | 304.80 |
| | 16 | 4.16 | 11.22 | 16.25 | |
| 40^{th} | 0 | 5.10 | 3.68 | 7.62 | 310.06 |
| | 16 | 4.21 | 10.58 | 15.82 | |
| 45^{th} | 0 | 5.13 | 3.63 | 7.90 | 326.35 |
| | 16 | 4.21 | 9.81 | 15.45 | |
| 50^{th} | 0 | 5.14 | 3.58 | 7.04 | 315.90 |
| | 16 | 4.22 | 10.55 | 15.57 | |
| 55^{th} | 0 | 5.13 | 3.90 | 8.02 | 304.20 |
| | 16 | 4.23 | 9.85 | 15.76 | |
| 60^{th} | 0 | 5.13 | 3.90 | 8.02 | 314.20 |
| | 16 | 4.23 | 9.85 | 15.76 | |

### Experiment Example 2

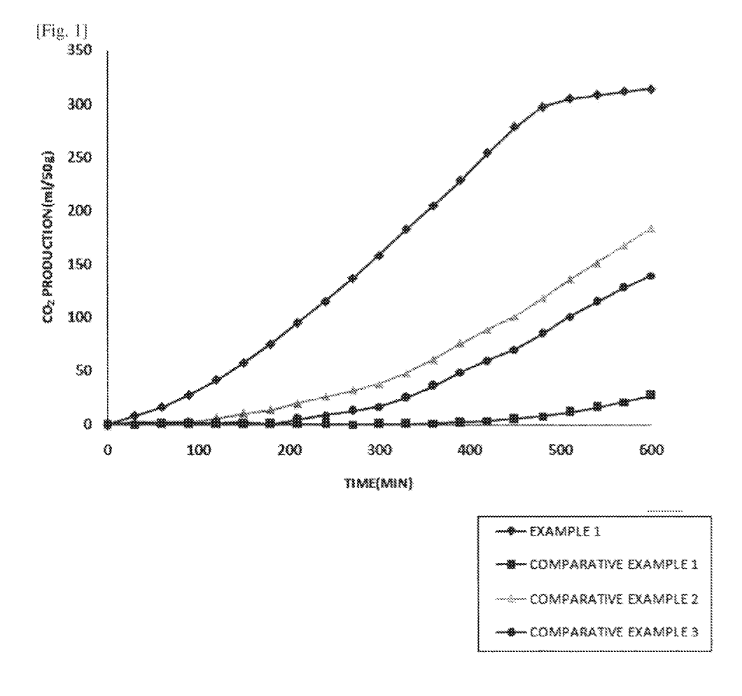

A CO₂ production of each of the sourdough starters prepared in Example 1 and Comparative Examples 1 to 3 was measured. Here, the CO₂ production was a value obtained by putting 50 g of each sample into a machine for measuring gassing power (fermometer) and measuring the sample at a temperature of 27° C. for 10 hours. The results are shown on a graph in FIG. 1.

As shown in FIG. 1, it could be seen that the CO₂ production of the sourdough starters prepared in Comparative Example 1 to 3 except for that of Example 1 was significantly reduced, and thus the sourdough starters were not suitable for making bread.

### Experiment Example 3

To check the fermentation characteristics of the natural sourdough starter according to a change in purified water, the pH value. TTA and gassing power (ml) of each of the natural sourdough starters prepared in Examples 1 and 2 were measured.

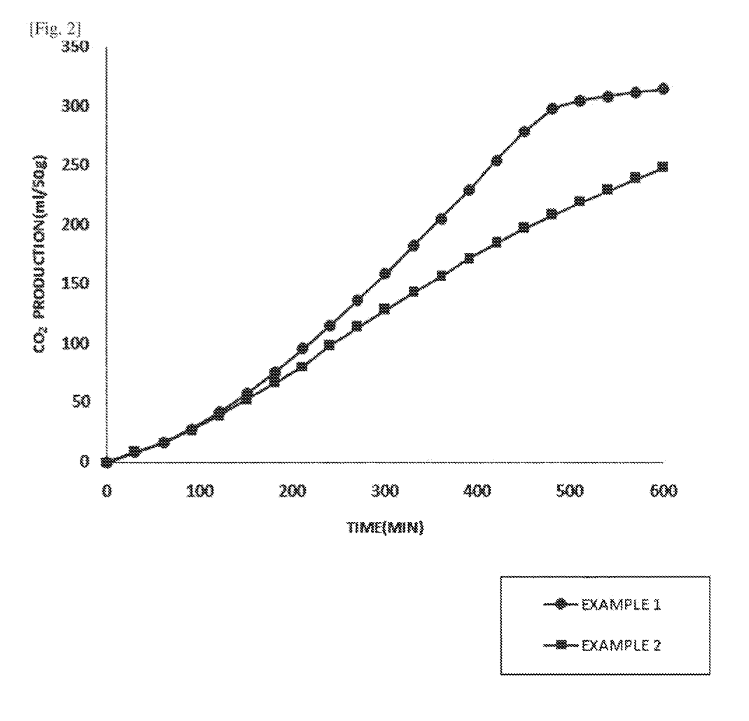

In this case, 20 g of a sample and 100 ml of distilled water were put into a 250 ml beaker, and homogenously mixed. Then, the pH value of the resulting mixture was measured using a pH meter. Also, the TTA was referred as an amount of a NaOH solution used when a sample was titrated with a 0.1N NaOH solution in pH measurement and the pH value of the sample reached pH 6.6 and 8.5, and the gassing power was a value obtained by putting 50 g of each sample into a machine for measuring gassing power (fermometer) and measuring the sample at a temperature of 27° C. for 10 hours. The results are listed in the following Table 3 and shown on a graph in FIG. 2.

TABLE 3

| | Fermentation | | TTA | | |
|---|---|---|---|---|---|
| Items | time (hr) | pH | pH 6.6 | pH 8.5 | Gassing power (ml) |
| Example 1 | 0 | 5.15 | 2.71 | 6.39 | 315.36 |
| | 16 | 4.18 | 10.16 | 15.37 | |
| Example 2 | 0 | 5.27 | 2.33 | 5.37 | 248.70 |
| | 16 | 4.35 | 8.44 | 13.28 | |

As listed in Table 3 and shown in FIG. 2, it could be seen that the sourdough starter prepared in Example 2, in which an amount of added purified water was reduced during a sub-culturing process, was not suitable for making bread since the sourdough starters since the sourdough starter showed lower gassing power and acid production than that of Example 1, and thus had a poor flavor.

### Experiment Example 4

To check the fermentation characteristics of the natural sourdough starter according to a change in fermentation temperature during a sub-culturing process, the pH value and TTA of each of the natural sourdough starters prepared in Examples 1, 3 and 4 were measured.

In this case, 20 g of a sample and 100 ml of distilled water were put into a 250 ml beaker, and homogenously mixed. Then, the pH value of the resulting mixture was measured using a pH meter. Also, the TTA was referred as an amount of a NaOH solution used when a sample was titrated with a 0.1N NaOH solution in pH measurement and the pH value of the sample reached pH 6.6 and 8.5. The results are listed in the following Table 4.

TABLE 4

| | |
|---|---|
| Fermentation tem- | TTA |

| Items | perature (° C.) | pH | pH 6.6 | pH 8.5 |
|---|---|---|---|---|
| Example 3 | 5 | 5.24 | 2.33 | 6.47 |
| | | 4.89 | 4.79 | 8.46 |
| Example 1 | 12 | 5.24 | 2.33 | 6.47 |
| | | 4.18 | 10.16 | 15.37 |
| Example 4 | 17 | 5.24 | 2.33 | 6.47 |
| | | 3.67 | 17.49 | 22.19 |

As listed in Table 4, it could be seen that the sourdough starter prepared in Example 3, in which a fermentation temperature was decreased, was not suitable for making bread since the sourdough starters since the sourdough starter did not form foams due to insufficient growth of microorganisms compared with that of Example 1, and thus showed low acid production due to poor fermentability and had a poor flavor.

Also, it could be seen that the sourdough starter prepared in Example 4, in which a fermentation temperature was decreased, was not suitable for making bread since the sourdough starters since the sourdough starter showed a fermentation reactivity with the microorganism and thus smelled alcohol due to anaerobic fermentation, compared with Example 1, the dough was rotted, and an excessive amount of the acid was produced.

### Experiment Example 5

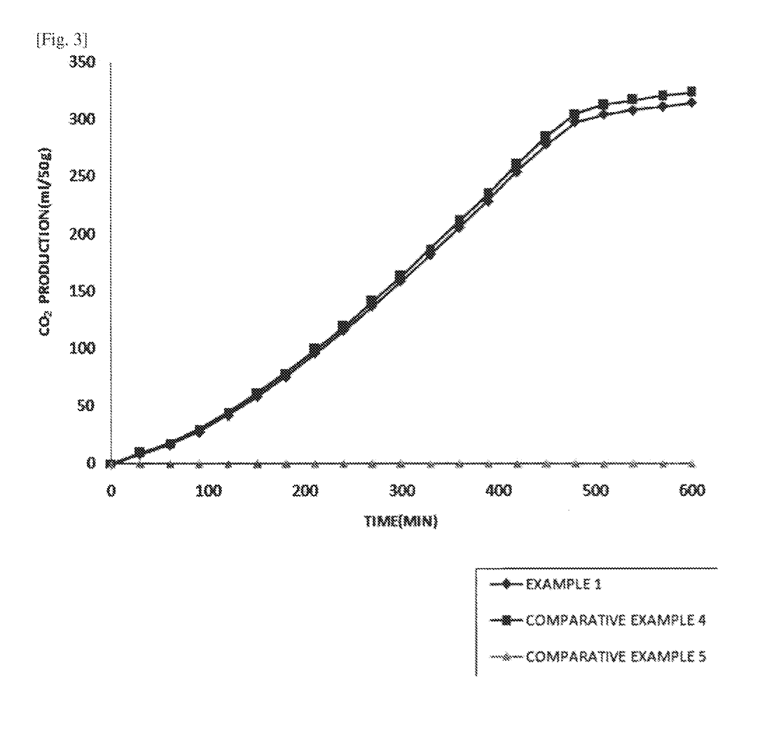

To determine that the microorganisms (yeast or lactic acid bacteria) associated with fermentation of the natural sourdough starter was not derived from wheat flour and rye flour but derived from the Nuruk, the gassing power (ml) of each of the sourdough starters prepared in Example 1 and Comparative Examples 4 and 5 was measured. The results are shown on a graph in FIG. 3.

As shown in FIG. 3, it could be seen that the sourdough starters prepared in Example 1 and Comparative Example 4 in which the microorganism starter was added during the starter culturing process showed the similar gassing power regardless of the kind of wheat flour, and the sourdough starter prepared in Comparative Example 5 in which the microorganism starter was not added showed nearly no gassing power.

For this reason, the microorganisms present in the microorganism starter acted as a main fermentation microorganism for natural sourdough starters and showed similar gassing power regardless of the kind of wheat flour. As result, it could be seen that the microorganisms did not have a significant effect on the microorganisms present in wheat flour or rye flour.

### Example 5

To determine an effect of the natural sourdough starter according to one exemplary embodiment of the present invention on the physical properties and characteristics of bread, a bread application test was performed. In this case, a dough was prepared using a straight dough method, and blending ratios of source materials used to make bread were listed in the following Table 5.

TABLE 5

| | Content (g) | | | |
|---|---|---|---|---|
| Source | Experimental | Experimental | Experimental | Experimental |
| material | Group 1 | Group 2 | Group 3 | Group 4 |
| Wheat flour | 70 | 70 | 70 | 70 |
| (MGPB) | | | | |
| Rye flour | 20 | 20 | 20 | 20 |
| (R700) | | | | |
| Rye flour | 10 | 10 | 10 | 10 |
| (R1800) | | | | |
| Natural sour- | 60 | 70 | 50 | 40 |
| dough starter | | | | |
| Sugar | 5.3 | 5.3 | 5.3 | 5.3 |
| Sun-dried | 1.8 | 1.8 | 1.8 | 1.8 |
| salt | | | | |
| Purified | 47 | 44 | 50 | 53 |
| water | | | | |

(Making Sliced Bread)

The natural sourdough starter prepared in Example 1, wheat flour and rye flour were blended and kneaded at the blending ratios as listed in Table 5 using a mixer. In this case, the first, second and third blendings were performed for 1 minute, 2 minutes and 1 minute, and the mixing was performed so that the final dough temperature reached 25 to 26° C. Then, the resulting mixture was put into a fermenter at a temperature of 27±1° C. and a relative humidity of 75%, and primarily fermented for 200 minutes.

The primarily fermented dough was divided into dough pieces having a weight of 300 to 350 g. Then, the dough pieces were made round, and intermediately fermented at a temperature of 27±1° C. and a relative humidity of 75% for 30 minutes. When the intermediate fermentation was completed, a push stick was used to remove a gas, and the dough pieces were shaped, put into a bread frame and panned. Thereafter, the dough pieces were put into a fermenter at a temperature of 38±1° C. and a relative humidity of 80 to 85%, and secondarily fermented for 120 minutes.

The secondarily fermented dough pieces were toasted for 45 minutes in a tech oven whose upper portion was set to 190° C. and lower portion was set to 220° C. Then, the toasted bread was taken out of the bread frame, and cooled at room temperature until an internal temperature of the tech oven decreased to 32° C.

Various kinds of bread were made by altering the blending ratios of the natural sourdough starter and purified water in the same manner as described above.

(Making Baguette)

The natural sourdough starter prepared in one example of the present invention, wheat flour and rye flour were blended and kneaded at the blending ratios as listed in Table 5 using a mixer. In this case, the first, second and third blendings were performed for 1 minute. 2 minutes and 1 minute, and the mixing was performed so that the final dough temperature reached 25 to 26° C. Then, the resulting mixture was put into a fermenter at a temperature of 27±1° C. and a relative humidity of 75%, and primarily fermented for 200 minutes.

The primarily fermented dough was divided into dough pieces having a weight of 150 g. Then, the dough pieces were made round, and intermediately fermented at a temperature of 27±1° C. and a relative humidity of 75% for 30 minutes. When the intermediate fermentation was completed, the dough pieces were shaped in the form of baguette, put on a piece of canvas cloth, put into a fermenter at a temperature of 38±1° C. and a relative humidity of 80 to 85%, and secondarily fermented for 60 minutes.

The secondarily fermented dough pieces were put on a thread paper and toasted for 18 minutes in a tech oven whose upper portion was set to 240° C. and lower portion was set to 220° C. while feeding steam for 3 to 4 seconds. Then, the toasted bread was cooled at room temperature until an internal temperature of the tech oven decreased to 32° C.

Various kinds of bread were made by altering the blending ratios of the natural sourdough starter and purified water in the same manner as described above.

(Making Healthy Bread)

The natural sourdough starter prepared in one example of the present invention, wheat flour and rye flour were blended and kneaded at the blending ratios as listed in Table 5 using a mixer. In this case, the first, second and third blendings were performed for 1 minute, 2 minutes and 1 minute, and the mixing was performed so that the final dough temperature reached 25 to 26° C. Then, the resulting mixture was put into a fermenter at a temperature of 27±1° C. and a relative humidity of 75%, and primarily fermented for 200 minutes.

The primarily fermented dough was divided into dough pieces having a weight of 200 to 250 g. Then, the dough pieces were made round, and intermediately fermented at a temperature of 27±1° C. and a relative humidity of 75% for 30 minutes. When the intermediate fermentation was completed, the dough pieces were shaped in a round form, put into a bamboo frame, put again into a fermenter at a temperature of 38±1° C. and a relative humidity of 80 to 85%, and secondarily fermented for 60 to 70 minutes.

The secondarily fermented dough pieces were put on a thread paper and toasted for 20 minutes in a tech oven whose upper portion was set to 240° C. and lower portion was set to 220° C. while feeding steam for 3 to 4 seconds. Then, the toasted bread was cooled at room temperature until an internal temperature of the tech oven decreased to 32° C.

Various kinds of bread were made by altering the blending ratios of the natural sourdough starter and purified water in the same manner as described above.

The physical property and sensory tests on the kinds of bread made thus were performed to calculate an average value of each item, which was listed in the following Tables 6 to 8. Also, the physical properties and sensory characteristics of the bread products are listed in the following Tables 6 to 8.

In this case, 30 sensory test participants in their twenties were selected in consideration of the health, reliability, and concern degree of experiments, and sufficiently be educated for the objects of experiments and evaluation methods. Then, the sensory test was performed.

More particularly, the sensory test was performed as follows: the sensory test participants ate one sample, recorded the evaluation results on the sample, rinsed their mouths with pure water for several seconds, ate another sample, and recorded the evaluation results on the another sample.

The evaluation was performed on each item using a 9-point scale method, and the smell and appearance were first evaluated.

TABLE 6

| | Sensory evaluation on application of sliced bread and | | | |
|---|---|---|---|---|
| | characteristics of bread product | | | |
| | Experimental | Experimental | Experimental | Experimental |
| Items | Group 1 | Group 2 | Group 3 | Group 4 |
| Volume | 8.2 | 8.0 | 7.8 | 7.2 |
| Texture | 8.1 | 8.1 | 7.3 | 6.9 |
| Flavor | 8.5 | 7.8 | 8.0 | 7.4 |
| pH | 4.20 | 4.16 | 4.24 | 4.33 |
| TTA (6.6/ | 6.71/9.84 | 6.90/10.10 | 6.55/9.58 | 6.25/9.09 |
| 8.5) | | | | |
| Water | 43.82 | 43.83 | 43.80 | 43.89 |
| content (%) | | | | |
| Acidity | 6 | 6.5 | 5.5 | 5.1 |

TABLE 7

| | Sensory evaluation on application of baguette and | | | |
|---|---|---|---|---|
| | characteristics of bread product | | | |
| | Experimental | Experimental | Experimental | Experimental |
| Items | Group 1 | Group 2 | Group 3 | Group 4 |
| Volume | 8.0 | 7.8 | 7.6 | 7.0 |
| Texture | 8.2 | 8.2 | 7.5 | 7.1 |
| Flavor | 8.4 | 7.7 | 7.9 | 7.3 |
| pH | 4.22 | 4.18 | 4.26 | 4.35 |
| TTA(6.6/ | 6.68/9.78 | 6.86/10.06 | 6.51/9.52 | 6.21/9.05 |
| 8.5) | | | | |
| Water | 43.01 | 43.02 | 43.00 | 42.99 |
| content (%) | | | | |
| Acidity | 6 | 6.5 | 5.5 | 5.1 |

TABLE 8

| | Sensory evaluation on application of healthy bread and | | | |
|---|---|---|---|---|
| | characteristics of bread product | | | |
| | Experimental | Experimental | Experimental | Experimental |
| Items | Group 1 | Group 2 | Group 3 | Group 4 |
| Volume | 8.2 | 8.0 | 7.8 | 7.2 |
| Texture | 8.1 | 8.1 | 7.3 | 6.9 |
| Flavor | 8.5 | 7.8 | 8.0 | 7.4 |
| pH | 4.18 | 4.14 | 4.22 | 4.28 |
| TTA (6.6/ | 6.75/9.88 | 6.99/10.20 | 6.59/9.63 | 6.30/9.19 |
| 8.5) | | | | |
| Water | 43.66 | 43.76 | 43.66 | 43.46 |
| content (%) | | | | |
| Acidity | 6 | 6.5 | 5.5 | 5.1 |

As listed in Tables 6 to 8, it could be seen that the bread, which was made by adding the natural sourdough starter prepared in one example of the present invention at a content 40 to 70% by weight to a composition, based on the total weight of the wheat flour, showed no significant difference according to the shape and kind of a bread product, and generally had more excellent fermentability and thus volume as the natural sourdough starter was added at an increasing content.

Also, as the content of the natural sourdough starter increased, the texture of bread which a participant felt in his/her mouth was soft as the bread did not become sticky and was easily broken. Therefore, it was revealed that the bread showed an excellent flavor since the bread was harmoniously mingled with proper acidity.

However, Experimental Group 2 in which the natural sourdough starter was added at a content of 70% by weight of the wheat flour showed a poor product-purchasing power in terms of flavor due to rather strong acidity, and the final volume of Experimental Group 2 tended to be reduced due to a decrease in structural strength of the dough compared with the experimental group in which the natural sourdough starter was added at a content of 60% by weight of the wheat flour.

Also, it was revealed that there was no significant difference in TTA and water content.

That is, when all the sliced bread, baguette and healthy bread were subjected to a sensory test, Experimental Group 1 in which the natural sourdough starter was added at a content of 60% by weight generally showed the most excellent degree of preference, compared with the other experimental groups.

The present invention has been described in detail. However, it should be understood that the detailed description and specific examples, while indicating preferred embodiments of the invention, are given by way of illustration only, since various changes and modifications within the scope of the invention will become apparent to those skilled in the art from this detailed description.

1. A method of preparing a natural sourdough starter, comprising:
mixing 450 to 500 parts by weight of purified water with 50 to 55 parts by weight of a Nuruk (Korean rice-wine starter), putting the resulting mixture into an incubator at a temperature of 20 to 23° C. and a relative humidity of 80 to 85% and separating a microorganism starter for 4 to 5 hours (starter separation process);
mixing 640 to 660 parts by weight of purified water, 940 to 960 parts by weight of wheat flour and 95 to 105 parts by weight of rye flour with 390 to 410 parts by weight of the microorganism starter separated(=Nuruk extract) in the starter separation process, putting the resulting mixture into a fermenter at a temperature of 24 to 26° C. and a relative humidity of 80 to 85% and fermenting the mixture for 46 to 50 hours (starter culturing process);
mixing 1,000 to 1,100 parts by weight of purified water, 900 to 1,000 parts by weight of wheat flour and 95 to 105 parts by weight of rye flour with 690 to 710 parts by weight of the starter culture broth cultured in the starter culturing process, putting the resulting mixture into an incubator at a temperature of 11 to 13° C. and fermenting the mixture for 14 to 16 hours (sourdough starter preparation process); and
putting the sourdough starter prepared in the sourdough starter preparation process into a refrigerator and refrigerating the sourdough starter at 2 to 4° C. (sourdough starter refrigeration process).

2. The method according to claim 1, further comprising:
mixing 1,000 to 1,100 parts by weight of purified water, 900 to 1,000 parts by weight of wheat flour and 95 to 105 parts by weight of rye flour with 690 to 710 parts by weight of the sourdough starter undergoing the sourdough starter refrigeration process, putting the resulting mixture into an incubator at a temperature of 11 to 13° C. and fermenting the mixture for 14 to 16 hours (sourdough starter subculturing process).

3. The method according to claim 1, wherein the Nuruk is a Songhak Nuruk having physical properties at pH 6.0 to pH 6.3 such as an acidity of 0.5 to 0.6, a water content of 7.4 to 7.6% by weight, lactic acid bacteria counts (cfu/g) of 2.6×10⁶, fungus counts (cfu/g) of 3.4×10⁸ and including a plurality of ingredients.

4. The method according to claim 1, wherein the microorganism starter separated from the Nuruk in the starter separation process is filtered using a sieve having a mesh size of 50 to 100 mesh to remove wheat bran ingredients.

5. A method of making bread, comprising:
(A) mixing 450 to 500 parts by weight of purified water with 50 to 55 parts by weight of a Nuruk, putting the resulting mixture into an incubator at a temperature of 20 to 23° C. and a relative humidity of 80 to 85% and separating a microorganism starter for 4 to 5 hours;
(B) mixing 640 to 660 parts by weight of purified water, 940 to 960 parts by weight of wheat flour and 95 to 105 parts by weight of rye flour with 390 to 410 parts by weight of the microorganism starter separated in Operation (A), putting the resulting mixture into a fermenter at a temperature of 24 to 26° C. and a relative humidity of 80 to 85% and fermenting and culturing the mixture 46 to 50 hours;
(C) mixing 1,000 to 1,100 parts by weight of purified water, 900 to 1,000 parts by weight of wheat flour and 95 to 105 parts by weight of rye flour with 690 to 710 parts by weight of the starter culture broth cultured in Operation (B), putting the resulting mixture into an incubator at a temperature of 11 to 13° C. and fermenting the mixture for 14 to 16 hours to prepare a sourdough starter;
(D) putting the sourdough starter prepared in Operation (C) into a refrigerator and refrigerating the sourdough starter at a temperature of 2 to 4° C.;
(E) kneading 55 to 65 parts by weight of the sourdough starter undergoing Operation (D) with 70 parts by weight of wheat flour, 30 parts by weight of rye flour, 5.3 parts by weight of a sugar, 1.8 parts by weight of a sun-dried salt and 44 to 50 parts by weight of purified water for 4 to 5 minutes using a mixer, putting the resulting mixture into a fermenter and primarily fermenting the mixture at a temperature of 27±1° C. and a relative humidity of 75% for 200 minutes;
(F) dividing the dough undergoing Operation (E) into dough pieces having a weight of 300 to 350 g, intermediately fermenting the dough at a temperature of 27±1° C. and a relative humidity of 75% for 30 minutes, removing a gas from the dough, shaping and panning the dough, putting the dough in a fermenter and secondarily fermenting the dough at a temperature of 38±1° C. and a relative humidity of 80 to 85% for 120 minutes; and
(G) toasting the secondarily fermented dough undergoing Operation (F) for 45 minutes in a tech oven whose upper portion is set to 190° C. and lower portion is set to 220° C. and cooling an internal temperature of the tech oven to 32° C. at room temperature.

6. A method of making bread, comprising:
(A) mixing 450 to 500 parts by weight of purified water with 50 to 55 parts by weight of a Nuruk, putting the resulting mixture in an incubator at a temperature of 20 to 23° C. and a relative humidity of 80 to 85% and separating a microorganism starter for 4 to 5 hours;
(B) mixing 640 to 660 parts by weight of purified water, 940 to 960 parts by weight of wheat flour and 95 to 105 parts by weight of rye flour with 390 to 410 parts by weight of the microorganism starter separated in Operation (A), putting the resulting mixture into a fermenter at a temperature of 24 to 26° C. and a relative humidity of 80 to 85% and fermenting and culturing the mixture 46 to 50 hours;
(C) mixing 1,000 to 1,100 parts by weight of purified water, 900 to 1,000 parts by weight of wheat flour and 95 to 105 parts by weight of rye flour with 690 to 710 parts by weight of the starter culture broth cultured in Operation (B), putting the resulting mixture into an incubator at a temperature of 11 to 13° C. and fermenting the mixture for 14 to 16 hours to prepare a sourdough starter;
(D) putting the sourdough starter prepared in Operation (C) into a refrigerator and refrigerating the sourdough starter at a temperature of 2 to 4° C.;
(E) kneading 55 to 65 parts by weight of the sourdough starter undergoing Operation (D) with 70 parts by weight of wheat flour, 30 parts by weight of rye flour, 5.3 parts by weight of a sugar, 1.8 parts by weight of a sun-dried salt and 44 to 50 parts by weight of purified water for 4 to 5 minutes using a mixer, putting the resulting mixture into a fermenter and primarily fermenting the mixture at a temperature of 27±1° C. and a relative humidity of 75% for 200 minutes;
(F) dividing the dough undergoing Operation (E) into dough pieces having a weight of 150 to 170 g, intermediately fermenting the dough at a temperature of 27±1° C. and a relative humidity of 75% for 30 minutes, shaping the dough, putting the shaped dough in a fermenter and secondarily fermenting the shaped dough at a temperature of 38±1° C. and a relative humidity of 80 to 85% for 60 minutes; and
(G) toasting the secondarily fermented dough undergoing Operation (F) for 18 minutes in a tech oven whose upper portion is set to 240° C. and lower portion is set to 220° C. and cooling an internal temperature of the tech oven to 32° C. at room temperature.

7. A method of making bread, comprising:
(A) mixing 450 to 500 parts by weight of purified water with 50 to 55 parts by weight of a Nuruk, putting the resulting mixture in an incubator at a temperature of 20 to 23° C. and a relative humidity of 80 to 85% and separating a microorganism starter for 4 to 5 hours;
(B) mixing 640 to 660 parts by weight of purified water, 940 to 960 parts by weight of wheat flour and 95 to 105 parts by weight of rye flour with 390 to 410 parts by weight of the microorganism starter separated in Operation (A), putting the resulting mixture into a fermenter at a temperature of 24 to 26° C. and a relative humidity of 80 to 85% and fermenting and culturing the mixture 46 to 50 hours;
(C) mixing 1,000 to 1,100 parts by weight of purified water, 900 to 1,000 parts by weight of wheat flour and 95 to 105 parts by weight of rye flour with 690 to 710 parts by weight of the starter culture broth cultured in Operation (B), putting the resulting mixture into an incubator at a temperature of 11 to 13° C. and fermenting the mixture for 14 to 16 hours to prepare a sourdough starter;
(D) putting the sourdough starter prepared in Operation (C) into a refrigerator and refrigerating the sourdough starter at a temperature of 2 to 4° C.;
(E) kneading 55 to 65 parts by weight of the sourdough starter undergoing Operation (D) with 70 parts by weight of wheat flour, 30 parts by weight of rye flour, 5.3 parts by weight of a sugar, 1.8 parts by weight of a sun-dried salt and 44 to 50 parts by weight of purified water for 4 to 5 minutes using a mixer, putting the resulting mixture into a fermenter and primarily fermenting the mixture at a temperature of 27±1° C. and a relative humidity of 75% for 200 minutes;
(F) dividing the dough undergoing Operation (E) into dough pieces having a weight of 200 to 250 g, intermediately fermenting the dough at a temperature of 27±1° C. and a relative humidity of 75% for 30 minutes, shaping the dough, putting the shaped dough in a fermenter and secondarily fermenting the shaped dough at a temperature of 38±1° C. and a relative humidity of 80 to 85% for 60 to 70 minutes and
(G) toasting the secondarily fermented dough undergoing Operation (F) for 20 minutes in a tech oven whose upper portion is set to 240° C. and lower portion is set to 220° C. and cooling an internal temperature of the tech oven to 32° C. at room temperature.

8. The method according to claim 2, wherein the Nuruk is a Songhak Nuruk having physical properties at pH 6.0 to pH 6.3 such as an acidity of 0.5 to 0.6, a water content of 7.4 to 7.6% by weight, lactic acid bacteria counts (cfu/g) of 2.6×10⁶, fungus counts (cfu/g) of 3.4×10⁸ and including a plurality of ingredients.

9. The method according to claim 2, wherein the microorganism starter separated from the Nuruk in the starter separation process is filtered using a sieve having a mesh size of 50 to 100 mesh to remove wheat bran ingredients.
